(19) United States
(12) Patent Application Publication
(10) Pub. No.: US 2025/0157751 A1
(43) Pub. Date: May 15, 2025

(54) POWER SWITCHING DEVICE

(71) Applicant: OMRON Corporation, Kyoto-shi (JP)

(72) Inventors: Katsumi MATSUSHITA, Kyoto-shi (JP); Kenichi TABATA, Kyoto-shi (JP); Yoshiki FUKUTA, Kyoto-shi (JP)

(21) Appl. No.: 18/922,961

(22) Filed: Oct. 22, 2024

(30) Foreign Application Priority Data
Nov. 13, 2023 (JP) 2023-193115

(51) Int. Cl. H01H 9/52; H01H 9/02

(52) U.S. Cl. CPC H01H 9/52; H01H 9/02

(57) ABSTRACT

A power switch including a communication unit communicably connected to an external device, a relay that opens and closes a power line supplying electric power from a power source to a load, a control unit that controls the relay based on information received from the external device via the communication unit, and a housing that accommodates the communication unit, the relay, and the control unit. The housing includes a first chamber and a second chamber separated from the first chamber by a partition wall, a first substrate mounted with the relay and constituting a part of the power line is disposed in the first chamber, and a second substrate including the communication unit and at least a part of the control unit and being connected to the first substrate is disposed in the second chamber.

### CROSS-REFERENCE TO RELATED APPLICATION

This application claims the benefit of priority to Japanese Patent Application Number 2023-193115 filed on Nov. 13, 2023. The entire contents of the above-identified application are hereby incorporated by reference.

### TECHNICAL FIELD

The present invention relates to a power switch.

### BACKGROUND ART

In the related art, a substrate including an EV power source line, being mounted with a switching relay and the like, and generating a large amount of heat, and a substrate including a communication unit and a control unit such as an MPU are accommodated in the same space of a case. For this reason, the substrate including the communication unit and the control unit may be affected by the substrate generating a large amount of heat and may be subjected to a temperature equal to or higher than the allowable operating temperature of the MPU or the like.

Patent Document 1 discloses a control device housed in a charging station for an EV, but does not disclose a countermeasure against heat generation by an EV power source line or the like.

### CITATION LIST

### Patent Literature

Patent Document 1: JP 2023-46536 A

### SUMMARY OF INVENTION

### Technical Problem

The present invention has been made in view of the above-described problem, and an object of the present invention is to provide a technique for making a substrate including a communication unit and a control unit less likely to be affected by a temperature rise of a substrate generating a large amount of heat.

### Solution to Problem

The present invention for solving the above-described problem provides a power switch including:
a communication unit communicably connected to an external device;
a relay that opens and closes a power line supplying electric power from a power source to a load;
a control unit that controls the relay based on information received from the external device via the communication unit; and
a housing that accommodates the communication unit, the relay, and the control unit,
wherein the housing includes a first chamber and a second chamber separated from the first chamber by a partition wall,
the first chamber is disposed with a first substrate, the first substrate being mounted with the relay and constituting a part of the power line, and
the second chamber is disposed with a second substrate, the second substrate including the communication unit and at least a part of the control unit and being connected to the first substrate.

According to this configuration, the second substrate including the communication unit and at least a part of the control unit is disposed in the second chamber separated by the partition wall from the first chamber, and the first substrate that is mounted with the relay for opening and closing the power line supplying the electric power from the power source to the load and constitutes a part of the power line is disposed in the first chamber. Thus, the second substrate is less likely to be affected by the temperature rise of the first substrate generating a large amount of heat. Therefore, the communication unit and the control unit can be operated within an appropriate temperature range, and the reliability of the operation of the power switch can be ensured.

In the present invention, the first chamber may include a hollow interior of the housing, and the second chamber may include a recessed portion recessed from the outside toward the hollow interior and opened toward the outside in the housing.

According to this configuration, since the first chamber can be formed by using the hollow interior of the housing and the second chamber can be formed by using the recessed portion of the housing which is opened toward the outside, it is possible to provide a power switch with a simple configuration in which the second substrate is less likely to be affected by the temperature rise of the first substrate generating a large amount of heat. In addition, since the recessed portion constituting the partition wall constitutes a part of the housing, heat from the first substrate can be released to the outside through the housing, and the effect of suppressing the temperature rise of the second substrate is high. Further, as described above, since the second chamber is formed using the recessed portion of the housing and the first chamber is formed to include the hollow interior of the housing including the recessed portion, the volume of the power switch can be reduced.

In the present invention, the housing may include a first housing portion in which the first substrate is disposed and a second housing portion including the recessed portion, and the first housing portion and the second housing portion may form the first chamber.

According to this configuration, it is possible to provide a power switch in which the second substrate is less likely to be affected by the temperature rise of the first substrate generating a large amount of heat, with a simple configuration including the first housing portion and the second housing portion.

In the present invention, a lid portion and a thermal conductive member may be further included, the lid portion covering an opening of the recessed portion, the thermal conductive member being provided between the lid portion and the second substrate and transferring heat from the second substrate to the lid portion.

According to this configuration, since the heat from the second substrate can be released from the lid portion to the outside of the power switch via the thermal conductive member, it is possible to suppress the temperature rise of the communication unit and the control unit.

In the present invention, the first substrate may include a bus bar constituting a part of the power line.

According to this configuration, since the power line capable of supplying large electric power includes the bus bar, it is possible to provide a power switch capable of switching large electric power without increasing the volume.

### Advantageous Effects of Invention

According to the present invention, it is possible to make the substrate including the communication unit and the control unit less likely to be affected by the temperature rise of the substrate generating a large amount of heat.

### BRIEF DESCRIPTION OF DRAWINGS

FIG. 1 is a diagram schematically illustrating an overall configuration of a charging system according to a first embodiment of the present invention.

FIG. 2 is an external perspective view of a power switching module according to the first embodiment of the present invention.

FIG. 3 is an exploded perspective view of the power switching module according to the first embodiment of the present invention.

FIG. 4 is a schematic cross-sectional view of the power switching module according to the first embodiment of the present invention.

### DESCRIPTION OF EMBODIMENTS

### Application Example

Hereinafter, an application example of the present invention will be described with reference to the drawings.

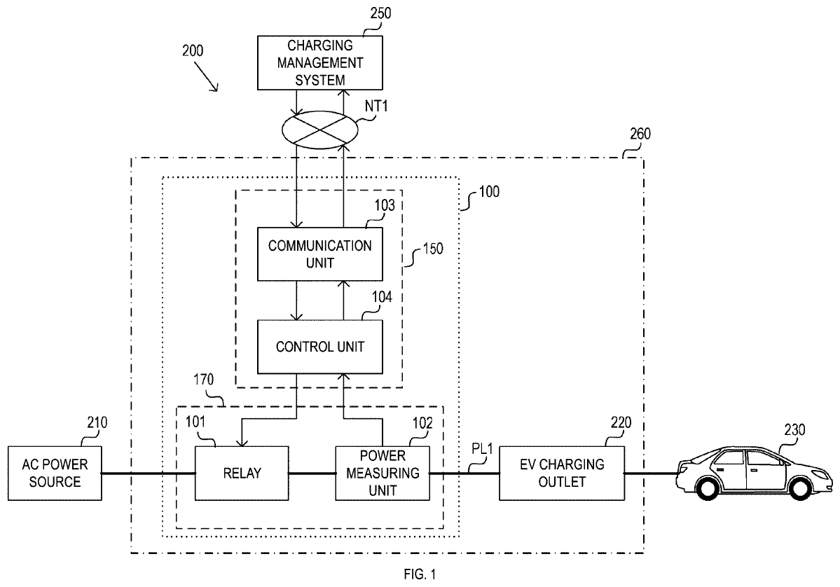

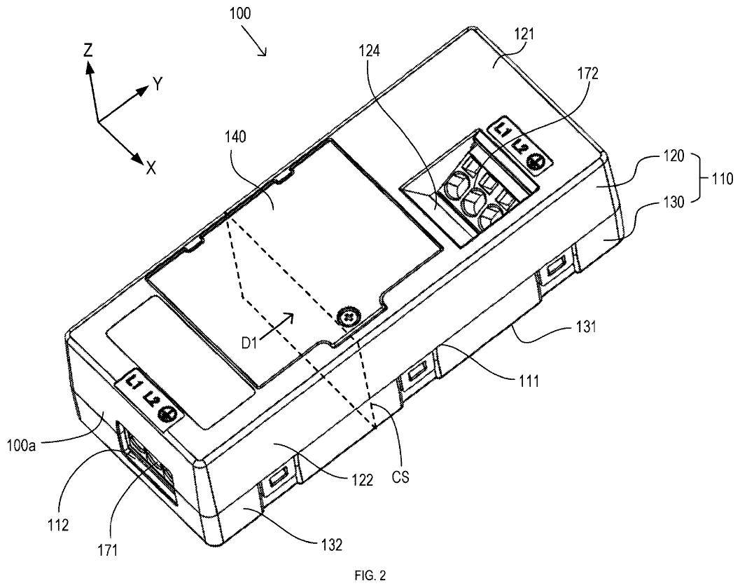

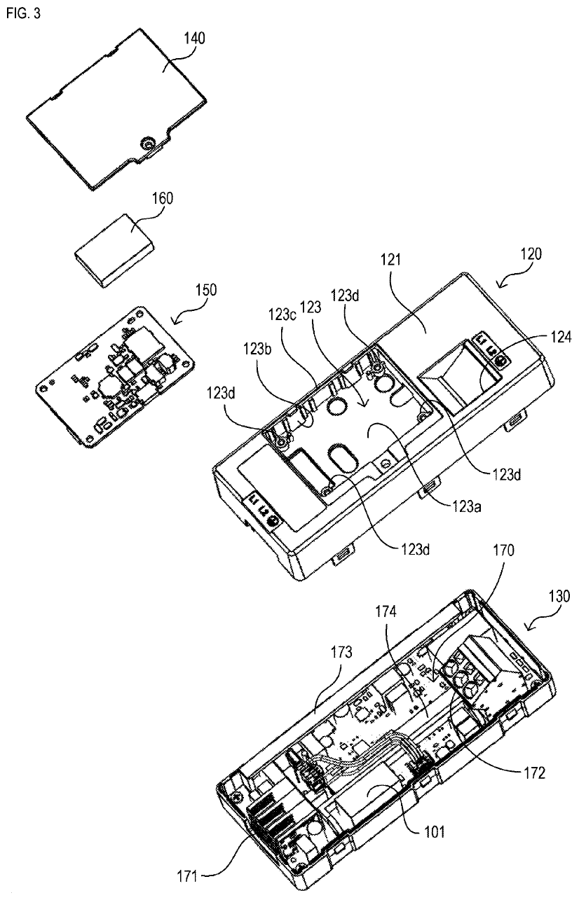

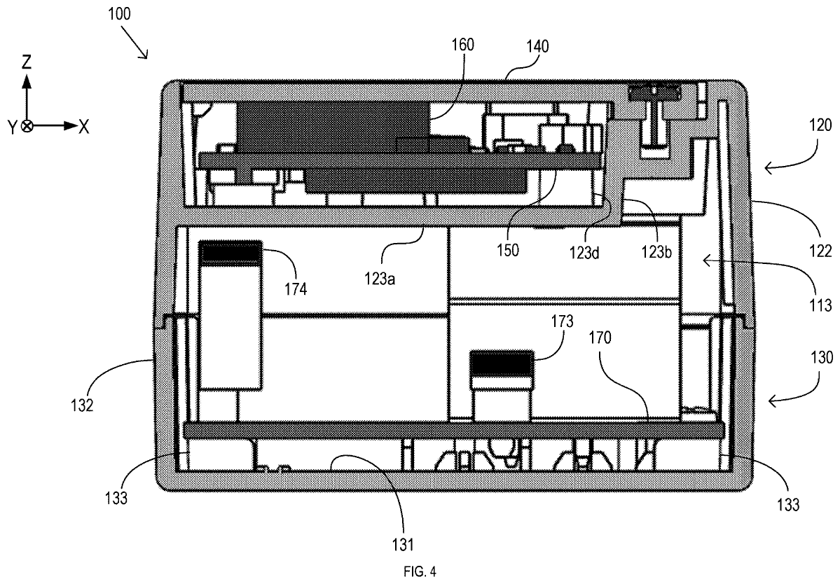

FIG. 2 is a schematic perspective view of a power switching module 100 used in a charging system 200 illustrated in FIG. 1. FIG. 3 is an exploded perspective view of the power switching module 100, and FIG. 4 is a cross-sectional view of the power switching module 100.

The charging system 200 includes an EV charging outlet 220, a power switching module 100 that opens and closes a power line PL1 for charging a storage battery of an electric vehicle (EV) 230 connected via the EV charging outlet 220 with electric power supplied from an AC power source 210, and a charging management system 250 connected to the power switching module 100 via a network NT1.

The power switching module 100 includes a relay 101 that opens and closes the power line PL1, a power measuring unit 102 that measures the electric power supplied to the EV 230 through the power line PL1, a communication unit 103 that transmits and receives information between the power switching module 100 and an external device by a predetermined communication method, and a control unit 104 that integrally controls the relay 101, the power measuring unit 102, and the communication unit 103.

The power switching module 100 is accommodated as a module in a housing of a pole or a box which is a charging facility 260 provided with the EV charging outlet 220.

As illustrated in FIG. 3, the power switching module 100 generally includes a housing 110 including a front side case 120 and a back side case 130, an opening cover 140, an IoT substrate 150, a thermal conductive sheet 160, and a power substrate 170.

Respective electronic components functioning as the communication unit 103 and the control unit 104 are mounted on the IoT substrate 150. The relay 101 and the power measuring unit 102 are mounted on the power substrate 170, forming a part of the power line PL1. In addition, bus bars 173 and 174 are connected to the power substrate 170 as a part of the power line PL1 to secure a capacity for electric power supplied from the AC power source 210 to the EV 230 via the power switching module 100. In addition to the electronic component functioning as the communication unit 103, an electronic component functioning as at least a part of the control unit 104 may be mounted on the IoT substrate 150.

The IoT substrate 150 is disposed in the recessed portion 123 provided on the front surface portion 121 side of the front side case 120, and is connected to the power substrate 170 disposed in the back side case 130. The IoT substrate 150 is retained at a position separated from the bottom portion 123a by retaining portions 123d having a cylindrical shape and being disposed at four corners of the bottom portion 123a of the recessed portion 123. The thermal conductive sheet 160 is disposed between the IoT substrate 150 and the opening cover 140 so as to be in close contact with the IoT substrate 150 and the opening cover 140, thereby performing a function of transferring heat generated in the IoT substrate 150 to the opening cover 140 and radiating the heat from the opening cover 140.

The power substrate 170 is retained so as to be separated from the back surface portion 131 by a retaining portion 133 disposed on the back surface portion 131 of the back side case 130. Each of the bus bars 173 and 174 extends from the power substrate 170 toward the front side, that is, the front side case 120 side, and is disposed along the longitudinal direction (Y-axis direction) of the back side case 130. As illustrated in FIG. 4, the power substrate 170 including the bus bars 173 and 174 is disposed in an internal space 113 defined by the front side case 120 and the back side case 130. Heat generated from the power substrate 170 is released to the periphery of the power switching module 100 via the bottom portion 123a of the recessed portion 123, the sidewall portion 122 of the front side case 120, and the back side case 130 surrounding the internal space 113.

As described above, the heat generated from the IoT substrate 150 is released to the front surface portion 121 side of the power switching module 100 via the thermal conductive sheet 160 and the opening cover 140. Since the IoT substrate 150 is disposed in the recessed portion 123 of the front side case 120, the IoT substrate 150 is separated from the internal space 113 in which the power substrate 170 is disposed by the bottom portion 123a of the recessed portion 123, and is retained by the retaining portions 123d so as to be also separated from the bottom portion 123a. Accordingly, the influence of heat generation in the power substrate 170 on the MPU or the like mounted on the IoT substrate 150 is reduced, and the temperature rise of the MPU or the like is suppressed.

### First Embodiment

Hereinafter, a charging system 200 including a power switching module 100 according to a first embodiment of the present invention will be described in more detail with reference to the drawings. However, the configuration of the apparatus and the system described in this embodiment should be changed as appropriate in accordance with various conditions. That is, the scope of the present invention is not intended to be limited to the embodiment described blow.

The charging system 200 includes an EV charging outlet 220, a power switching module 100 that opens and closes a power line PL1 for charging a storage battery of an electric vehicle (EV) 230 connected via the EV charging outlet 220 with electric power supplied from an AC power source 210, and a charging management system 250 connected to the power switching module 100 via a network NT1. Here, the AC power source 210 and the EV 230 correspond to the power source and the load of the present invention, respectively. The power line PL1 corresponds to the power line of the present invention. The power switching module 100 corresponds to the power switch of the present invention, and the charging management system 250 corresponds to the external device of the present invention.

The power switching module 100 mainly includes a relay 101, a power measuring unit 102, a communication unit 103, and a control unit 104. The relay 101 opens and closes the power line PL1 connecting the AC power source 210 and the EV charging outlet 220. The power measuring unit 102 measures electric power supplied to the EV 230 through the power line PL1. The communication unit 103 is an interface that transmits and receives information between the power switching module 100 and an external device by a predetermined communication method. The control unit 104 integrally controls the relay 101, the power measuring unit 102, and the communication unit 103. Here, the relay 101, the communication unit 103, and the control unit 104 correspond to the relay, the communication unit, and the control unit of the present invention, respectively.

The control unit 104 includes a processor such as an MPU and a memory.

An operation example of the above-described charging system 200 will be described below.

The charging management system 250 is, for example, a computer device such as a plurality of servers disposed on a cloud.

The charging management system 250 monitors and controls the power switching module 100 connected via the network NT1.

For example, the power switching module 100 is accommodated as a module in the housing of a pole or a box which is a charging facility 260 provided with the EV charging outlet 220. The relay 101 and the power measuring unit 102 are disposed on the power line PL1 that connects the AC power source 210 and the EV charging outlet 220 and supplies AC electric power supplied from the AC power source 210 to the EV 230 via the EV charging outlet 220. The relay 101 opens and closes the power line PL1 in accordance with an instruction from the control unit 104 to charge the storage battery of the EV 230. The power measuring unit 102 measures electric power or an amount of the electric power supplied from the AC power source 210 to the EV 230 via the EV charging outlet 220. The charging management system 250 monitors and controls the operation of the power switching module 100 based on necessary information transmitted from the communication unit 103.

FIG. 2 is a perspective view illustrating an outer shape of the power switching module 100, and FIG. 3 is an exploded perspective view of the power switching module 100. Note that in FIG. 3, members are omitted as appropriate for convenience of description.

The power switching module 100 is disposed in the housing of a pole or a box which is the charging facility 260 such that the Z direction illustrated in FIG. 2 is the front side (the −(minus) Z direction is the back side), the Y direction is the upper side (the −Y direction is the lower side), and the X direction is the right side when facing the front side (the −X direction is the left side when facing the front side). At this time, the front side is a side on which the EV charging outlet 220 is disposed in the charging facility 260.

The power switching module 100 generally includes a housing 110 including a front side case 120 and a back side case 130, an opening cover 140, an IoT substrate 150, a thermal conductive sheet 160, and a power substrate 170. The housing 110 having a substantially rectangular parallelepiped shape with a hollow interior is divided into the front side case 120 on the front side and the back side case 130 on the back side along a dividing plane 111 parallel to a front surface portion 121 and a back surface portion 131. The front side case 120 and the back side case 130 are coupled to each other by appropriate coupling means. The front side case 120 has a substantially rectangular cylindrical shape with a bottom and includes a sidewall portion 122 rising from the circumference of the front surface portion 121 having a substantially rectangular shape parallel to the XY plane in a direction (−Z direction) orthogonal to the front surface portion 121. Similarly, the back side case 130 has a substantially rectangular cylindrical shape with a bottom and includes a sidewall portion 132 rising from the circumference of the back surface portion 131 having a substantially rectangular shape parallel to the XY plane in a direction (Z direction) orthogonal to the back surface portion 131. With the divided structure in which the housing 110 is divided into the front side case 120 and the back side case 130, the housing 110 of the power switching module 100 can be formed with a simple configuration. Here, the housing 110, the front side case 120, and the back side case 130 correspond to the housing, the second housing portion, and the first housing portion of the present invention, respectively. The opening cover 140 and the thermal conductive sheet 160 correspond to the lid portion and the thermal conductive member of the present invention, respectively. The IoT substrate 150 and the power substrate 170 correspond to the second substrate and the first substrate of the present invention, respectively.

Near the lower end in the longitudinal direction (Y-axis direction) of the front surface portion 121 of the front side case 120, a recessed portion 123 having a substantially rectangular parallelepiped shape that is recessed from the front side to the back side is formed. The recessed portion 123 has a bottom portion 123a parallel to the front surface portion 121, and a sidewall portion 123b which is rising from the circumference of the bottom portion 123a perpendicularly to the bottom portion 123a and is connected to the front surface portion 121, whereby an opening 123c opened to the outside (front side) is formed. The opening 123c of the recessed portion 123 provided in the front side case 120 is covered with the opening cover 140, which is a substantially rectangular plate-like member, in an openable and closable manner. Here, the recessed portion 123 corresponds to the recessed portion of the present invention.

An opening 124 having a substantially square shape is formed near the upper end in the longitudinal direction of the front surface portion 121 of the front side case 120, and an output connector 172 to be described below is exposed through the opening 124 toward the front side.

On the lower side (−Y direction) of the power switching module 100, an opening 112 is provided across the sidewall portion 122 of the front side case 120 and the sidewall portion 132 of the back side case 130, and an input connector 171 for connecting an input cable that connects the AC power source 210 and the power switching module 100 is exposed through the opening 112. The output connector 172 for connecting an output cable that connects the power switching module 100 and the EV charging outlet 220 is disposed at the front side of the power switching module 100.

In the power switching module 100, a circuit substrate is divided into the IoT substrate 150 and the power substrate 170 as described above. Respective electronic components functioning as the communication unit 103 and the control unit 104 are mounted on the IoT substrate 150. The relay 101 and the power measuring unit 102 are mounted on the power substrate 170, forming a part of the power line PL1. In addition, bus bars 173 and 174 are connected to the power substrate 170 as a part of the power line PL1 to secure a capacity for electric power supplied from the AC power source 210 to the EV 230 via the power switching module 100. Here, the bus bars 173 and 174 correspond to the bus bar of the present invention.

The thermal conductive sheet 160 is a sheet made of a thermally conductive member such as silicon, and is disposed between the IoT substrate 150 and the opening cover 140.

FIG. 4 illustrates a schematic cross-sectional view of the power switching module 100. In FIG. 4, members are omitted as appropriate for convenience of description. The cross section illustrated in FIG. 4 is a cross section of the portion indicated by a broken line CS in FIG. 2 as viewed from the direction of an arrow D1.

The IoT substrate 150 is disposed in the recessed portion 123 provided on the front surface portion 121 side of the front side case 120, and is connected to the power substrate 170 disposed in the back side case 130. The IoT substrate 150 is retained at a position separated from the bottom portion 123a by retaining portions 123d having a cylindrical shape and being disposed at four corners of the bottom portion 123a of the recessed portion 123.

The thermal conductive sheet 160 disposed between the IoT substrate 150 and the opening cover 140 is slightly crushed between the opening cover 140 and the IoT substrate 150 in a state where the opening cover 140 is closed to come into close contact with the IoT substrate 150 and the opening cover 140, thereby performing a function of transferring heat generated in the IoT substrate 150 to the opening cover 140 and radiating the heat from the opening cover 140. Here, the recessed portion 123 corresponds to the second chamber of the present invention. In addition thereto, the opening cover 140 may also correspond to the second chamber of the present invention.

The power substrate 170 is retained so as to be separated from the back surface portion 131 by a retaining portion 133 disposed on the back surface portion 131 of the back side case 130. Each of the bus bars 173 and 174 extends from the power substrate 170 toward the front side, that is, the front side case 120 side, and is disposed along the longitudinal direction (Y-axis direction) of the back side case 130. As illustrated in FIG. 4, the power substrate 170 including the bus bars 173 and 174 is disposed in an internal space 113 defined by the front side case 120 and the back side case 130. Heat generated from the power substrate 170 is released to the periphery of the power switching module 100 via the bottom portion 123a and the sidewall portion 123b of the recessed portion 123, the sidewall portion 122 of the front side case 120, and the back side case 130 surrounding the internal space 113. Here, the internal space 113 corresponds to the hollow interior of the present invention, and the bottom portion 123a and the sidewall portion 123b of the recessed portion 123, the sidewall portion 122 of the front side case 120, and the back side case 130 correspond to the first chamber of the present invention. The bottom portion 123a and the sidewall portion 123b of the recessed portion 123 correspond to the partition wall of the present invention.

As described above, the heat generated from the IoT substrate 150 is released to the front surface portion 121 side of the power switching module 100 via the thermal conductive sheet 160 and the opening cover 140. Since the IoT substrate 150 is disposed in the recessed portion 123 of the front side case 120, the IoT substrate 150 is separated from the internal space 113 in which the power substrate 170 is disposed by the bottom portion 123a of the recessed portion 123, and is retained by the retaining portions 123d so as to be also separated from the bottom portion 123a. Accordingly, the influence of heat generation in the power substrate 170 on the MPU or the like mounted on the IoT substrate 150 is reduced, and the temperature rise of the MPU or the like is suppressed. Thus, the communication unit 103 and the control unit 104 can be operated within an appropriate temperature range, and the reliability of the operation of the power switching module 100 can be ensured. In addition, by configuring the power switching module 100 as described above, the entire apparatus can be made compact by suppressing the volume, and the power switching module 100 can be installed in a post or box charging facility in which the volume of an internal space is limited.

Note that, in order to enable the comparison between the constituent features of the present invention and the configurations of the embodiment, the constituent features of the present invention will be described below with reference signs in the drawings.

### Supplementary Note 1

A power switch (100) including:
a communication unit (103) communicably connected to an external device (250);
a relay (101) that opens and closes a power line (PL1) supplying electric power from a power source (210) to a load (230);
a control unit (104) that controls the relay (101) based on information received from the external device (250) via the communication unit (103); and
a housing (110) that accommodates the communication unit (103), the relay (101), and the control unit (104),
wherein the housing (110) includes a first chamber (123a, 123b, 122, 130) and a second chamber (123) separated from the first chamber (123a, 123b, 122, 130) by a partition wall (123a, 123b),
the first chamber (123a, 123b, 122, 130) is disposed with a first substrate (170), the first substrate (170) being mounted with the relay (101) and constituting a part of the power line (PL1), and
the second chamber (123) is disposed with a second substrate (150), the second substrate (150) including the communication unit (103) and at least a part of the control unit (104) and being connected to the first substrate (170).

### Supplementary Note 2

The power switch (100) according to Supplementary Note 1,
wherein the first chamber (123a, 123b, 122, 130) includes a hollow interior (113) of the housing (110), and
the second chamber (123) includes a recessed portion (123) recessed from an outside toward the hollow interior (113) and opened toward the outside in the housing (110).

### Supplementary Note 3

The power switch (100) according to Supplementary Note 2, wherein the housing (110) includes
a first housing portion (130) in which the first substrate (170) is disposed, and
a second housing portion (120) including the recessed portion (123), and
the first housing portion (130) and the second housing portion (120) form the first chamber (123a, 123b, 122, 130).

### Supplementary Note 4

The power switch (100) according to Supplementary Note 2 or 3, further including
a lid portion (140) covering an opening (123c) of the recessed portion (123), and
a thermal conductive member (160) being provided between the lid portion (140) and the second substrate (150) and transferring heat from the second substrate (150) to the lid portion (140).

### Supplementary Note 5

The power switch (100) according to any one of Supplementary Notes 1 to 4, wherein the first substrate (170) includes a bus bar (173, 174) constituting a part of the power line (PL1).

1. A power switch comprising:
a communication unit communicably connected to an external device;
a relay configured to open and close a power line supplying electric power from a power source to a load;
a control unit configured to control the relay based on information received from the external device via the communication unit; and
a housing configured to accommodate the communication unit, the relay, and the control unit,
wherein the housing includes a first chamber and a second chamber separated from the first chamber by a partition wall,
the first chamber is disposed with a first substrate, the first substrate being mounted with the relay and constituting a part of the power line, and
the second chamber is disposed with a second substrate, the second substrate including the communication unit and at least a part of the control unit and being connected to the first substrate.

2. The power switch according to claim 1,
wherein the first chamber includes a hollow interior of the housing, and
the second chamber includes a recessed portion recessed from an outside toward the hollow interior and opened toward the outside in the housing.

3. The power switch according to claim 2,
wherein the housing includes
a first housing portion in which the first substrate is disposed, and
a second housing portion including the recessed portion, and
the first housing portion and the second housing portion form the first chamber.

4. The power switch according to claim 2, further comprising
a lid portion covering an opening of the recessed portion, and
a thermal conductive member being provided between the lid portion and the second substrate and transferring heat from the second substrate to the lid portion.

5. The power switch according to claim 1, wherein the first substrate includes a bus bar constituting a part of the power line.
